(19) United States
(12) Patent Application Publication
(10) Pub. No.: US 2018/0349544 A1
(43) Pub. Date: Dec. 6, 2018

(54) METHODS FOR PERFORMING REGISTER RETIMING WITH HYBRID INITIAL STATES

(71) Applicant: Intel Corporation, Santa Clara, CA (US)

(72) Inventors: Mahesh A. Iyer, Fremont, CA (US); Ian Milton, Whitby (CA); Dai Le, Toronto (CA)

(73) Assignee: Intel Corporation, Santa Clara, CA (US)

(21) Appl. No.: 15/610,223

(22) Filed: May 31, 2017

(51) Int. Cl. G06F 17/50

(52) U.S. Cl. CPC G06F 17/5081; G06F 17/5072; G06F 17/5077

(57) ABSTRACT

An integrated circuit design may include registers and combinational logic. Integrated circuit design computing equipment may perform retiming for the circuit design, where registers are moved across one or more portions of the combinational logic. The registers may be retimed while considering hybrid initial states of the registers. At least some of the registers may have don't-care initial states. When performing backward retiming, initial states of the retimed registers may be computed that is consistent with the original initial state and functionality of the combinational logic while maximizing the number of don't-care initial states. When performing forward retiming across non-justifiable combinational elements, any don't-care initial states may be assumed to be equal to a deterministic binary value, and the initial states of the retimed registers may be computed that is consistent with the original initial states and functionality of the combinational logic.

### BACKGROUND

This relates to integrated circuits and, more particularly, to ways for performing register retiming for an integrated circuit design.

Every transition from one technology node to the next has resulted in smaller transistor geometries and thus potentially more functionality implemented per unit area on an integrated circuit die. Synchronous integrated circuits have further benefited from this development as evidenced by reduced interconnect and cell delays, which have led to performance increases.

To further increase the performance, solutions such as register retiming have been proposed, where registers are moved among portions of combinational logic to achieve a more balanced distribution of delays between registers, and thus the integrated circuit may be operated at a potentially higher clock frequency.

The registers are typically implemented using clock-edge-triggered flip-flops. Prior to retiming, when the integrated circuit is powered up, these digital flip-flops may be powered to an unknown initial state.

Therefore, a reset sequence is typically provided to the flip-flops to reset the flip-flops and bring them to a known reset state.

However, after retiming, the retimed integrated circuit may behave differently from the integrated circuit prior to retiming. In some cases, the same reset sequence provided to the flip-flops prior to retiming will not work with the retimed flip-flops. It is within this context that the embodiments herein arise.

### BRIEF DESCRIPTION OF THE DRAWINGS

FIG. 1 is a diagram of an illustrative programmable integrated circuit in accordance with an embodiment.

FIG. 2 is a diagram of illustrative retiming operations in accordance with an embodiment.

FIG. 3 is a diagram of an illustrative pipelined routing resource which uses a register to pipeline a routing signal in accordance with an embodiment.

FIG. 4 is a diagram of a circuit design system that may be used to design integrated circuits in accordance with an embodiment.

FIG. 5 is a diagram of illustrative computer-aided design (CAD) tools that may be used in a circuit design system in accordance with an embodiment.

FIG. 6 is a flow chart of illustrative steps for designing an integrated circuit in accordance with an embodiment.

FIG. 7 is a diagram of an illustrative graph of possible states for a set of pipeline registers in accordance with an embodiment.

FIG. 8A is a diagram of an illustrative circuit prior to retiming in accordance with an embodiment.

FIG. 8B is a diagram of a retimed version of the circuit of FIG. 8A in accordance with an embodiment.

FIGS. 9A and 9B show an illustrative scenario in which maintaining initial states can restrict retiming in accordance with an embodiment.

FIG. 10A is a diagram of an illustrative justifiable circuit element in accordance with an embodiment.

FIG. 10B is a diagram of an illustrative non-justifiable circuit element in accordance with an embodiment.

FIG. 10C is a diagram of an illustrative fan-out circuit that is a non-justifiable element in accordance with an embodiment.

FIG. 11 is a diagram showing how an integrated circuit may have hybrid initial states in accordance with an embodiment.

FIGS. 12A-12F illustrate various backward retiming examples in accordance with some embodiments.

FIGS. 13A-13E illustrate various forward retiming examples in accordance with some embodiments.

FIG. 14 is a flow chart of illustrative steps for performing register retiming with hybrid initial states in accordance with an embodiment.

### DETAILED DESCRIPTION

The presented embodiments relate to integrated circuits and, more particularly, to modeling registers during register retiming operations.

Performing retiming operations on an integrated circuit may change the configuration of registers within the integrated circuit. In some cases, the retimed registers will not accurately reset using the reset sequence for registers prior to retiming (e.g., a reset sequence provided by a designer for a corresponding circuit design).

In accordance with an embodiment, sequential equivalence may be maintained by keeping track of don't-care and care initial state bits in an integrated circuit design. Backward retiming may be allowed as long as there are no state conflicts, whereas don't-care initial states may be set to a deterministic value when performing forward retiming across a certain type of combinational element (e.g., when retiming across non-justifiable elements). Operated in this way, functionality and sequential equivalence can be maintained while improving operating frequency.

It will be recognized by one skilled in the art, that the present exemplary embodiments may be practiced without some or all of these specific details. In other instances, well-known operations have not been described in detail in order not to unnecessarily obscure the present embodiments.

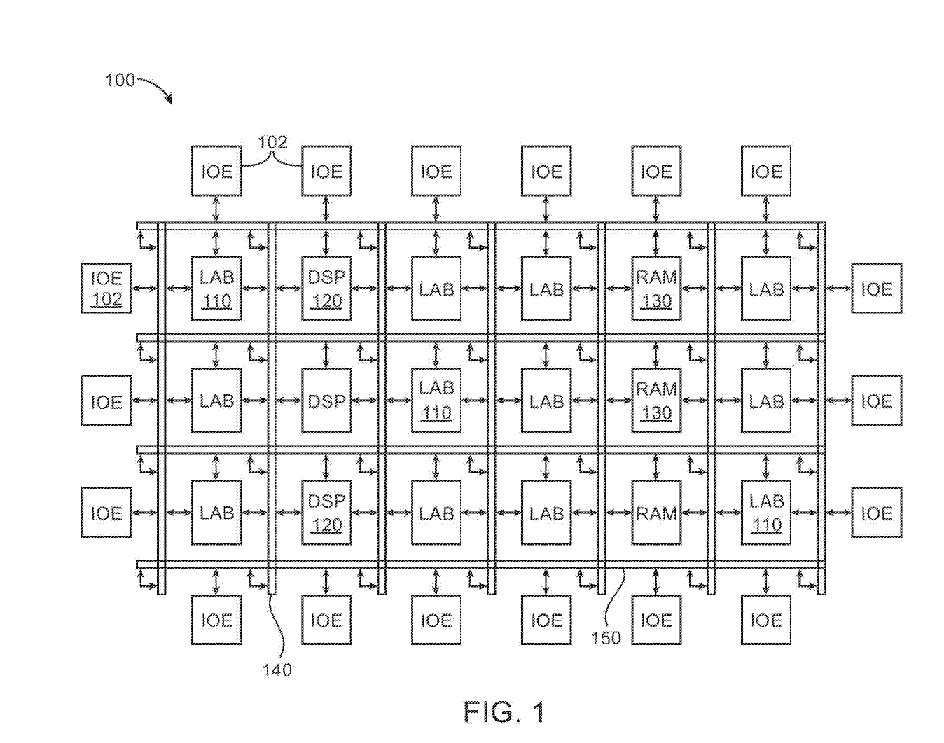

An illustrative embodiment of a programmable integrated circuit such as programmable logic device (PLD) 100 that may be configured to implement a circuit design is shown in FIG. 1. As shown in FIG. 1, the programmable logic device (PLD) may include a two-dimensional array of functional blocks, including logic array blocks (LABs) 110 and other functional blocks, such as random access memory (RAM) blocks 130 and digital signal processing (DSP) blocks 120, for example. Functional blocks such as LABs 110 may include smaller programmable regions (e.g., logic elements, configurable logic blocks, or adaptive logic modules) that receive input signals and perform custom functions on the input signals to produce output signals.

Programmable logic device 100 may contain programmable memory elements. Memory elements may be loaded with configuration data (also called programming data) using input-output elements (IOEs) 102. Once loaded, the memory elements each provide a corresponding static control signal that controls the operation of an associated functional block (e.g., LABs 110, DSP 120, RAM 130, or input-output elements 102).

In a typical scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration RAM (CRAM), or programmable memory elements.

In addition, the programmable logic device may have input-output elements (IOEs) 102 for driving signals off of PLD 100 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The PLD may also include programmable interconnect circuitry in the form of vertical routing channels 140 (i.e., interconnects formed along a vertical axis of PLD 100) and horizontal routing channels 150 (i.e., interconnects formed along a horizontal axis of PLD 100), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 1, are intended to be included within the scope of the present invention. For example, the routing topology may include wires that travel diagonally or that travel horizontally and vertically along different parts of their extent as well as wires that are perpendicular to the device plane in the case of three dimensional integrated circuits, and the driver of a wire may be located at a different point than one end of a wire. The routing topology may include global wires that span substantially all of PLD 100, fractional global wires such as wires that span part of PLD 100, staggered wires of a particular length, smaller local wires, or any other suitable interconnection resource arrangement.

If desired, programmable logic device (PLD) 100 may be configured to implement a custom circuit design. For example, the configuration RAM may be programmed such that LABs 110, DSP 120, and RAM 130, programmable interconnect circuitry (i.e., vertical channels 140 and horizontal channels 150), and the input-output elements 102 form the circuit design implementation.

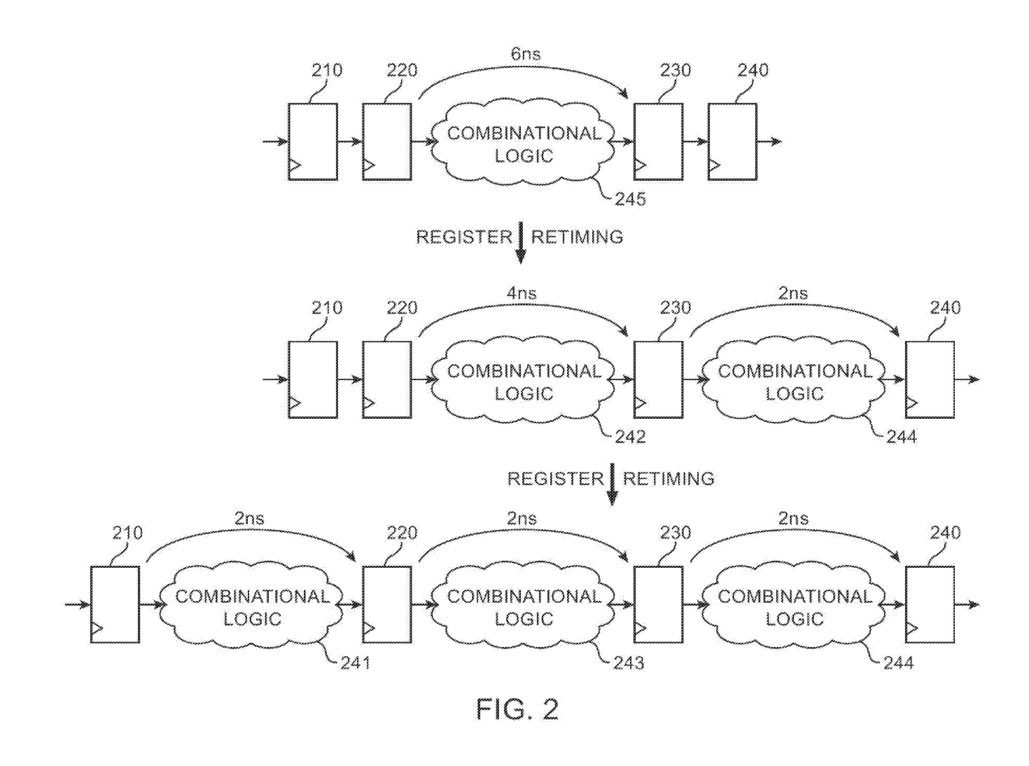

FIG. 2 shows an example of different versions of a circuit design that PLD 100 may implement. The first version of the circuit design may include registers 210, 220, 230, 240, and combinational logic 245. Register 210 may send a signal to register 220; register 220 may send the signal through combinational logic 245 to register 230; and register 230 may send the signal to register 240. As an example, the delay on the path from register 220 through combinational logic 245 to register 230 may have a delay of 6 nanoseconds (ns), whereas the delay between register 210 and 220 and between registers 230 and 240 may have a delay of 0 ns. Thus, the first version of the circuit design may operate at a frequency of 166 MHz.

Performing register retiming on the first version of the circuit design may create a second version of the circuit design. For example, register 230 may be pushed back through a portion of combinational logic 245 (sometimes referred to as backward retiming), thereby separating combinational logic 245 of the first version of the circuit design into combinational logic 242 and 244 of the second version of the circuit design. In the second version of the circuit design, register 210 may send a signal to register 220; register 220 may send the signal through combinational logic 242 to register 230; and register 230 may send the signal through combinational logic 244 to register 240.

As an example, the delay on the path from register 220 through combinational logic 242 to register 230 may have a delay of 4 ns, and the delay from register 230 through combinational logic 244 to register 240 may have a delay of 2 ns. Thus, the second version of the circuit design may operate at a frequency of 250 MHz, which is limited by the path with the longest delay (sometimes referred to as the critical path).

Performing register retiming on the second version of the circuit design may create a third version of the circuit design. For example, register 220 may be pushed forward through a portion of combinational logic 242 (sometimes referred to as “forward” retiming), thereby separating combinational logic 242 of the second version of the circuit design into combinational logic 241 and 243 of the third version of the circuit design. In the third version of the circuit design, register 210 may send a signal through combinational logic 241 to register 220; register 220 may send the signal through combinational logic 243 to register 230; and register 230 may send the signal through combinational logic 244 to register 240.

As an example, the delay on the paths from register 210 through combinational logic 241 to register 220, from register 220 through combinational logic 243 to register 230, and from register 230 through combinational logic 244 to register 240 may all have a delay of 2 ns. Thus, the third version of the circuit design may operate at a frequency of 500 MHz, which is thrice the frequency at which the first version of the circuit design may operate.

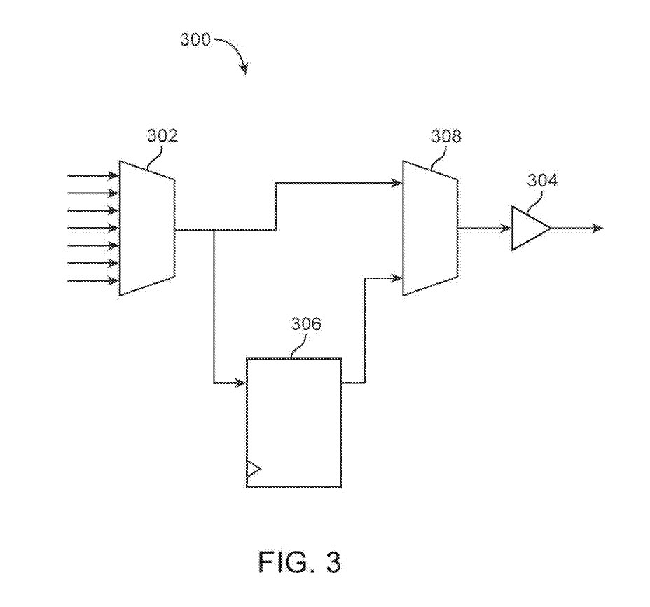

If desired, any interconnect routing resources on an integrated circuit may include pipeline elements, which can facilitate register retiming. FIG. 3 depicts a pipelined routing resource 300 which uses a register in accordance with an embodiment. As shown, the pipelined routing resource 300 includes a first multiplexer 302, a driver 304, a register 306, and a second multiplexer 308.

Multiplexer 302 may be a driver input multiplexer (DIM) or a functional block input multiplexer (FBIM). A DIM may select a signal from multiple sources and send the selected signal to driver 304 that drives a corresponding wire. The multiple sources may include signals from outputs of functional blocks and other routing wires that travel in the same or in an orthogonal direction to the wire. A FBIM outputs a signal to a functional block and may select the signal from multiple routing wires.

As shown in FIG. 3, multiplexer 302 may be pipelined by providing its output to the data input of register 306. Multiplexer 308 in pipelined routing resource 300 may receive the output of multiplexer 302 directly and may also receive the data output from register 306.

Although pipelined routing resource 300 includes register 306, it will be recognized by one skilled in the art that different register implementations may be used to store a routing signal such as an edge-triggered flip-flop, a pulse latch, a transparent-low latch, a transparent-high latch, just to name a few. Thus, in order not to unnecessarily obscure the present embodiments, we refer to the storage circuit in the pipelined routing resource as a pipeline storage element.

Multiplexer 308 may enable the pipelined routing resource 300 to be either used in a non-pipeline mode or in a pipeline register mode. In the non-pipeline mode, the output of multiplexer 308 selects the direct output of multiplexer 302. In the pipeline mode, multiplexer 308 may select the output of register 306. Multiplexer 308 may provide its output to driver circuit 304, and the output of driver circuit 304 may be used to drive a routing wire. The routing wire may span multiple functional blocks (e.g., for a pipelined routing resource with a DIM). Alternatively, the routing wire may be inside a functional block (e.g., for a pipelined routing resource with a FBIM).

Every DIM/FBIM may include a register such as register 306 such that all the routing multiplexers are pipelined. However, in some embodiments, that may be unnecessary as the capabilities provided may exceed design requirements. Thus, in certain embodiments only a fraction, such as one-half or one-fourth, of the routing multiplexers may be pipelined. For example, a signal may take 150 picoseconds (ps) to traverse a wire of a given length, but a clock signal may be constrained to operate with a 650 ps clock cycle. Thus, providing a pipeline register such as register 306 every fourth wire may be sufficient in this example. Alternatively, the registers may be placed more frequently than every fourth wire (e.g., every second wire) to provide a higher degree of freedom in selection of which registers are used.

Pipelined routing resources such as pipelined routing resource 300 may facilitate register retiming operations, such as the register retiming illustrated in FIG. 2. For example, consider the scenario in which register 230 is implemented by a first instance of a pipelined routing element that is operated in pipeline register mode (i.e., register 230 is implemented by register 306 of a first instance of a pipelined routing resource 300). Consider further that the path from register 220 through combinational logic 245 to register 230 includes a second instance of a pipelined routing element that is operated in non-pipeline mode. Thus, switching the first instance of the pipelined routing element from operating in pipeline register mode to operating in non-pipeline mode and switching the second instance of the pipelined routing element from operating in non-pipeline mode to operating in pipeline register mode may transform the first version into the second version of the circuit design presented in FIG. 2.

Computer-aided design (CAD) tools in a circuit design system may evaluate whether register retiming may improve the performance of a current version of a circuit design or whether the current version of the circuit design meets a given performance criterion. If desired, and if the CAD tools determine that register retiming would improve the performance of the current version of the circuit design or that the current version of the circuit design misses the given performance criterion, the CAD tools may execute register retiming operations that transform the current version of the circuit design into another version of the circuit design (e.g., as illustrated in FIG. 2).

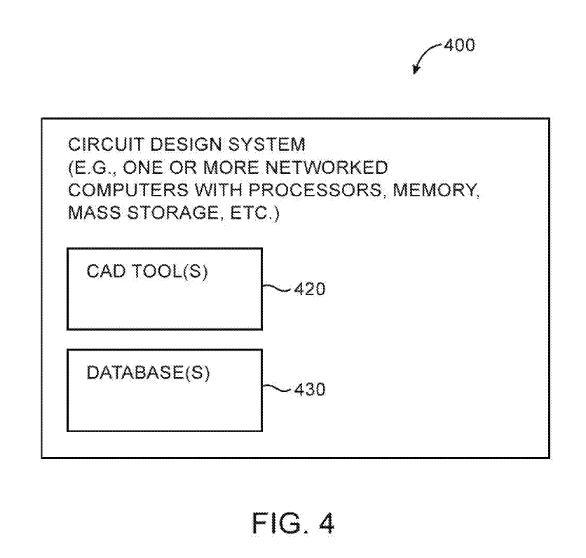

An illustrative circuit design system 400 in accordance with an embodiment is shown in FIG. 4. Circuit design system 400 may be implemented on integrated circuit design computing equipment. For example, system 400 may be based on one or more processors such as personal computers, workstations, etc. The processor(s) may be linked using a network (e.g., a local or wide area network). Memory in these computers or external memory and storage devices such as internal and/or external hard disks or non-transitory computer-read storage media may be used to store instructions and data.

Software-based components such as computer-aided design tools 420 and databases 430 reside on system 400. During operation, executable software such as the software of computer aided design tools 420 runs on the processor(s) of system 400. Databases 430 are used to store data for the operation of system 400. In general, software and data may be stored on any computer-readable medium (storage) in system 400. Such storage may include computer memory chips, removable and fixed media such as hard disk drives, flash memory, compact discs (CDs), digital versatile discs (DVDs), Blu-ray discs (BDs), other optical media, and floppy diskettes, tapes, or any other suitable memory or storage device(s). When the software of system 400 is installed, the storage of system 400 has instructions and data that cause the computing equipment in system 400 to execute various methods (processes). When performing these processes, the computing equipment is configured to implement the functions of the circuit design system.

The computer aided design (CAD) tools 420, some or all of which are sometimes referred to collectively as a CAD tool, a circuit design tool, or an electronic design automation (EDA) tool, may be provided by a single vendor or by multiple vendors. Tools 420 may be provided as one or more suites of tools (e.g., a compiler suite for performing tasks associated with implementing a circuit design in a programmable logic device) and/or as one or more separate software components (tools). Database(s) 430 may include one or more databases that are accessed only by a particular tool or tools and may include one or more shared databases. Shared databases may be accessed by multiple tools. For example, a first tool may store data for a second tool in a shared database. The second tool may access the shared database to retrieve the data stored by the first tool. This allows one tool to pass information to another tool. Tools may also pass information between each other without storing information in a shared database if desired.

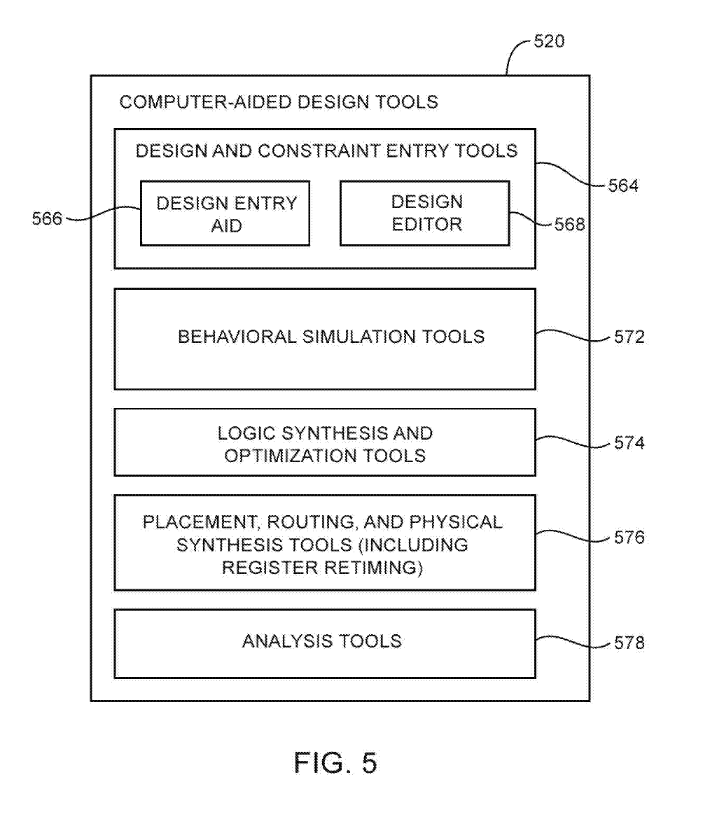

Illustrative computer aided design tools 520 that may be used in a circuit design system such as circuit design system 400 of FIG. 4 are shown in FIG. 5.

The design process may start with the formulation of functional specifications of the integrated circuit design (e.g., a functional or behavioral description of the integrated circuit design). A circuit designer may specify the functional operation of a desired circuit design using design and constraint entry tools 564. Design and constraint entry tools 564 may include tools such as design and constraint entry aid 566 and design editor 568. Design and constraint entry aids such as aid 566 may be used to help a circuit designer locate a desired design from a library of existing circuit designs and may provide computer-aided assistance to the circuit designer for entering (specifying) the desired circuit design.

As an example, design and constraint entry aid 566 may be used to present screens of options for a user. The user may click on on-screen options to select whether the circuit being designed should have certain features. Design editor 568 may be used to enter a design (e.g., by entering lines of hardware description language code), may be used to edit a design obtained from a library (e.g., using a design and constraint entry aid), or may assist a user in selecting and editing appropriate prepackaged code/designs.

Design and constraint entry tools 564 may be used to allow a circuit designer to provide a desired circuit design using any suitable format. For example, design and constraint entry tools 564 may include tools that allow the circuit designer to enter a circuit design using truth tables. Truth tables may be specified using text files or timing diagrams and may be imported from a library. Truth table circuit design and constraint entry may be used for a portion of a large circuit or for an entire circuit.

As another example, design and constraint entry tools 564 may include a schematic capture tool. A schematic capture tool may allow the circuit designer to visually construct integrated circuit designs from constituent parts such as logic gates and groups of logic gates. Libraries of preexisting integrated circuit designs may be used to allow a desired portion of a design to be imported with the schematic capture tools.

If desired, design and constraint entry tools 564 may allow the circuit designer to provide a circuit design to the circuit design system 400 using a hardware description language such as Verilog hardware description language (Verilog HDL), Very High Speed Integrated Circuit Hardware Description Language (VHDL), SystemVerilog, or a higher-level circuit description language such as OpenCL or SystemC, just to name a few. The designer of the integrated circuit design can enter the circuit design by writing hardware description language code with editor 568. Blocks of code may be imported from user-maintained or commercial libraries if desired.

After the design has been entered using design and constraint entry tools 564, behavioral simulation tools 572 may be used to simulate the functional performance of the circuit design. If the functional performance of the design is incomplete or incorrect, the circuit designer can make changes to the circuit design using design and constraint entry tools 564. The functional operation of the new circuit design may be verified using behavioral simulation tools 572 before synthesis operations have been performed using tools 574. Simulation tools such as behavioral simulation tools 572 may also be used at other stages in the design flow if desired (e.g., after logic synthesis). The output of the behavioral simulation tools 572 may be provided to the circuit designer in any suitable format (e.g., truth tables, timing diagrams, etc.).

Once the functional operation of the circuit design has been determined to be satisfactory, logic synthesis and optimization tools 574 may generate a gate-level netlist of the circuit design, for example using gates from a particular library pertaining to a targeted process supported by a foundry, which has been selected to produce the integrated circuit. Alternatively, logic synthesis and optimization tools 574 may generate a gate-level netlist of the circuit design using gates of a targeted programmable logic device (i.e., in the logic and interconnect resources of a particular programmable logic device product or product family).

Logic synthesis and optimization tools 574 may optimize the design by making appropriate selections of hardware to implement different logic functions in the circuit design based on the circuit design data and constraint data entered by the logic designer using tools 564. As an example, logic synthesis and optimization tools 574 may perform multi-level logic optimization and technology mapping based on the length of a combinational path between registers in the circuit design and corresponding timing constraints that were entered by the logic designer using tools 564.

After logic synthesis and optimization using tools 574, the circuit design system may use tools such as placement, routing, and physical synthesis tools 576 to perform physical design steps (layout synthesis operations). Tools 576 can be used to determine where to place each gate of the gate-level netlist produced by tools 574. For example, if two counters interact with each other, tools 576 may locate these counters in adjacent regions to reduce interconnect delays or to satisfy timing requirements specifying the maximum permitted interconnect delay. Tools 576 create orderly and efficient implementations of circuit designs for any targeted integrated circuit (e.g., for a given programmable integrated circuit such as a field-programmable gate array (FPGA)).

Tools such as tools 574 and 576 may be part of a compiler suite (e.g., part of a suite of compiler tools provided by a programmable logic device vendor). In certain embodiments, tools such as tools 574, 576, and 578 may also include timing analysis tools such as timing estimators. This allows tools 574 and 576 to satisfy performance requirements (e.g., timing requirements) before actually producing the integrated circuit.

As an example, tools 574 and 576 may perform register retiming by moving registers through combinational logic (e.g., through logic AND, OR, XOR, and other suitable gates, look-up tables (LUTs), multiplexers, arithmetic operators, etc.). Tools 574 and 576 may push registers forward or backward across combinational logic as illustrated in FIG. 2. If desired, tools 574 and 576 may perform forward and backward pushes of registers by configuring pipelined routing resources such as pipelined routing resource 300 of FIG. 3 to operate in non-pipeline mode or as a pipelined routing element. Physical synthesis tools 576 used in this way can therefore also be used to perform register retiming.

After an implementation of the desired circuit design has been generated using tools 576, the implementation of the design may be analyzed and tested using analysis tools 578. For example, analysis tools 578 may include timing analysis tools, power analysis tools, or formal verification tools, just to name few.

After satisfactory optimization operations have been completed using tools 520 and depending on the targeted integrated circuit technology, tools 520 may produce a mask-level layout description of the integrated circuit or configuration data for programming the programmable logic device.

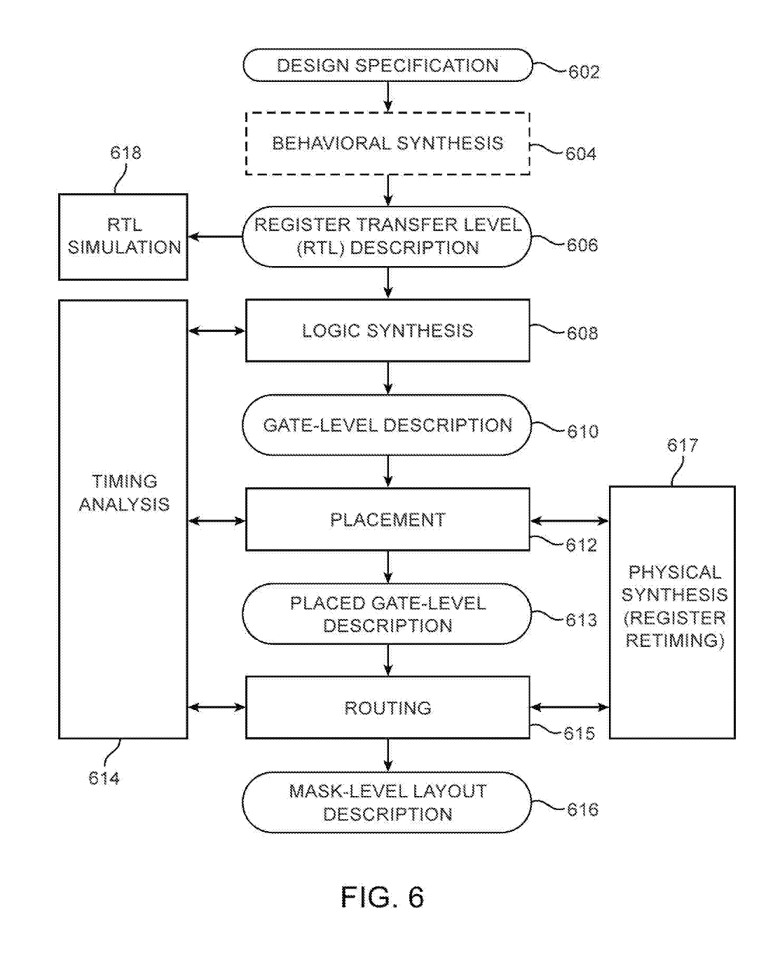

Illustrative operations involved in using tools 520 of FIG. 5 to produce the mask-level layout description of the integrated circuit are shown in FIG. 6. As shown in FIG. 6, a circuit designer may first provide a design specification 602. The design specification 602 may, in general, be a behavioral description provided in the form of an application code (e.g., C code, C++ code, SystemC code, OpenCL code, etc.). In some scenarios, the design specification may be provided in the form of a register transfer level (RTL) description 606.

The RTL description may have any form of describing circuit functions at the register transfer level. For example, the RTL description may be provided using a hardware description language such as the Verilog hardware description language (Verilog HDL or Verilog), the SystemVerilog hardware description language (SystemVerilog HDL or SystemVerilog), or the Very High Speed Integrated Circuit Hardware Description Language (VHDL). If desired, a portion or all of the RTL description may be provided as a schematic representation.

In general, the behavioral design specification 602 may include untimed or partially timed functional code (i.e., the application code does not describe cycle-by-cycle hardware behavior), whereas the RTL description 606 may include a fully timed design description that details the cycle-by-cycle behavior of the circuit at the register transfer level.

Design specification 602 or RTL description 606 may also include target criteria such as area use, power consumption, delay minimization, clock frequency optimization, or any combination thereof. The optimization constraints and target criteria may be collectively referred to as constraints.

Those constraints can be provided for individual data paths, portions of individual data paths, portions of a design, or for the entire design. For example, the constraints may be provided with the design specification 602, the RTL description 606 (e.g., as a pragma or as an assertion), in a constraint file, or through user input (e.g., using the design and constraint entry tools 564 of FIG. 5), to name a few.

At step 604, behavioral synthesis (sometimes also referred to as algorithmic synthesis) may be performed to convert the behavioral description into an RTL description 606. Step 604 may be skipped if the design specification is already provided in form of an RTL description.

At step 618, behavioral simulation tools 572 may perform an RTL simulation of the RTL description, which may verify the functionality of the RTL description. If the functionality of the RTL description is incomplete or incorrect, the circuit designer can make changes to the HDL code (as an example). During RTL simulation 618, actual results obtained from simulating the behavior of the RTL description may be compared with expected results.

During step 608, logic synthesis operations may generate gate-level description 610 using logic synthesis and optimization tools 574 from FIG. 5. If desired, logic synthesis operations may perform register retiming as illustrated in FIG. 2 according to the constraints that are included in design specification 602 or RTL description 606. The output of logic synthesis 608 is gate-level description 610.

During step 612, placement operations using for example placement tools 576 of FIG. 5 may place the different gates in gate-level description 610 in a preferred location on the targeted integrated circuit to meet given target criteria (e.g., minimize area and maximize routing efficiency or minimize path delay and maximize clock frequency or any combination thereof). The output of placement 612 is placed gate-level description 613, that satisfies the legal placement constraints of the underlying target device.

During step 615, routing operations using for example routing tools 576 of FIG. 5 may connect the gates from the placed gate-level description 613. Routing operations may attempt to meet given target criteria (e.g., minimize congestion, minimize path delay and maximize clock frequency or any combination thereof). The output of routing 615 is a mask-level layout description 616 (sometimes referred to as routed gate-level description 616).

While placement and routing is being performed at steps 612 and 615, physical synthesis operations 617 may be concurrently performed to further modify and optimize the circuit design (e.g., using physical synthesis tools 576 of FIG. 5). If desired, register retiming operations may be performed during physical synthesis step 617. For example, registers in the placed gate-level description 613 or the routed gate-level description 616 may be moved around according to the constraints that are included in design specification 602 or RTL description 606.

As an example, register retiming operations may change the configuration of some pipelined routing resources (e.g., some instances of pipelined routing resource 300 of FIG. 3) from operating in pipeline register mode to operating in non-pipelined mode and the configuration of other pipelined routing resources (e.g., other instances of pipelined routing resources 300 of FIG. 3) from operating in non-pipelined mode to operating in pipeline register mode. To avoid obscuring the embodiments, the change of states for pipeline routing resources may be referred to simply as a move (e.g., movement) of pipeline registers (e.g., pipelined routing resources that operate in pipeline register mode).

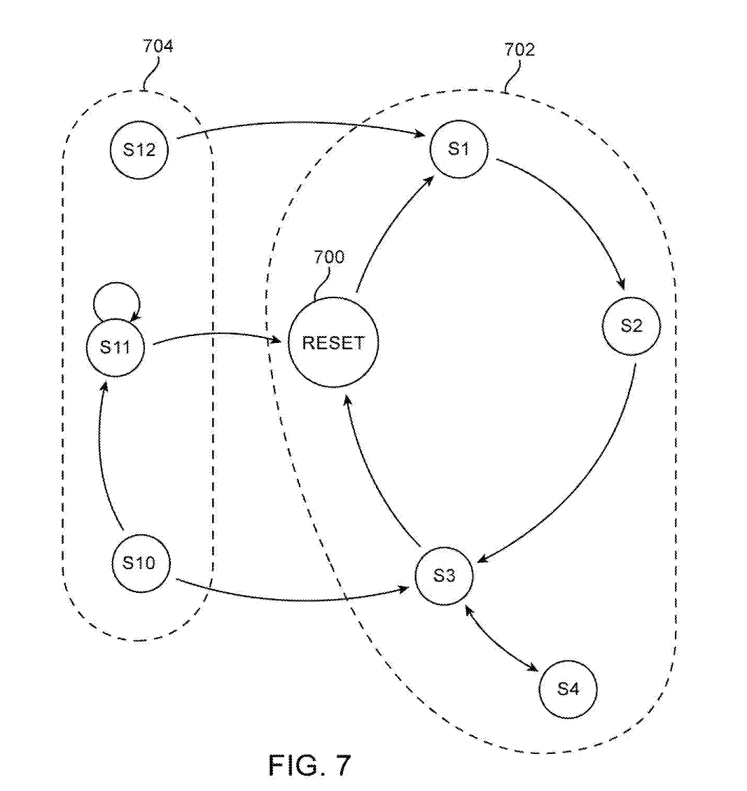

FIG. 7 is a diagram showing the number of possible states associated with an illustrative set of data latching registers within an integrated circuit. As shown in the state diagram of FIG. 7, the possible states may include states S1, S2, S3, S4, S10, S11, S12, and Reset. Each state may represent values stored in a set of registers along a data path on the integrated circuit at a given point in time.

The registers may transition from one state to another in response to a clock signal (e.g., at a rising edge of a clock signal, at a falling edge of a clock signal, at both the rising and falling edges of a clock signal, etc.), as indicated by the directionality of the arrows. During a state transition, the register will receive and latch a new set of values, which will change the value at their outputs (e.g., the state of each register will be updated). As an example, a first rising clock edge may cause the registers to transition from state S12 to state S1. As another example, a second rising clock edge may be a self-cycling transition, such as when state S11 is maintained.

Integrated circuit 10 may include power-up circuitry or startup circuitry (e.g., initialization circuitry) that powers up the registers in an unknown state. To properly operate device 10, it may be desirable to reset the registers to a known state. The known initialized state may be referred to as a reset state such as reset state 700. To reach reset state 700, one or more clock signals may be clocked to provide a reset sequence (e.g., a particular set of transitions between the possible states) to the registers. Initialization circuitry may be used to provide the reset sequence to the registers upon device startup, if desired. The reset sequence may be a set of transitions that guarantees that no matter which state the registers powered up to, the reset state 700 may be reached using the reset sequence. For example, consider a scenario in which device 10 is powered up in state S10. The reset sequence may cause the integrated circuit to transition from state S10 to state S11 and then to reset state 700. This is merely illustrative. If desired, any reset sequence may be used to bring the pipeline registers to reset state 700.

After reaching reset state 700, the pipeline registers may operate in a smaller set of states referred to as “legal” states such as states 702. In other words, after resetting the pipeline registers, only legal states 702 can be reached by the pipeline registers. States that cannot be reached after entering reset sate 700 may be referred to as “illegal” (see, e.g., illegal states 704). In the example of FIG. 7, all further transitions from reset state 700 may cycle between states S1, S2, S3, S4, and Reset only within legal region 702.

The state diagram of FIG. 7 is merely illustrative. In general, an integrated circuit may be powered up in any number of legal or illegal states, the reset sequence may ensure that the integrated circuit reaches the reset state, and the integrated circuit may then be operated in any of the legal states.

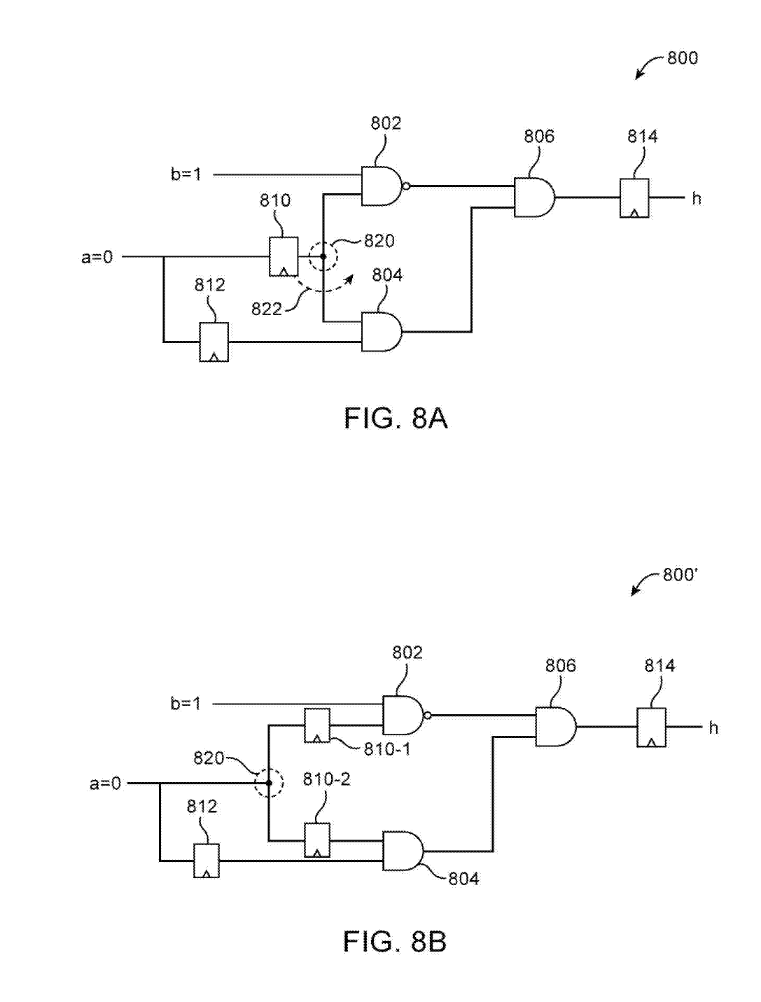

In general, retiming operations can affect the reset sequence. For example, a given reset sequence that can effectively reset a circuit to the reset state might be unable to fully reset that circuit after retiming. FIGS. 8A and 8B illustrate an exemplary circuit such as circuit 800 before and after retiming. As shown in FIG. 8A, circuit 800 may include logic NAND gate 802, logic AND gates 804 and 806, and data registers 810, 812, and 814. One or more of registers 810, 812, and 814 may be pipeline registers.

Circuit 800 may receive two input signals a and b. Registers 810 and 812 may receive input signal a. Logic NAND gate 802 may have a first input that receives signal b and a second input that is coupled to the output of register 810. Logic AND gate 804 may have a first input that is coupled to the output of register 810 and a second input that is coupled to the output of register 812. Logic AND gate 806 may have a first input that is coupled to the output of NAND gate 802 and a second input that is coupled to the output of AND gate 804. Register 814 may be coupled at the output of AND gate 806 and may provide signal h at its output. Registers 810, 812, and 814 may be clocked using the same clock signal (e.g., registers 810, 812, and 814 may be part of the same clock domain). This is merely illustrative. If desired, any suitable clocking configuration may be used.

The power-up process for circuit 800 may be performed using initialization circuitry (not shown) within integrated circuit 100. The initialization circuitry may apply a reset sequence on circuit 800. As described in connection with FIG. 7, after power-up and prior to reset, the pipeline registers may be at an unknown state. Registers 810, 812, and 814 may be reset using a reset sequence to provide a known reset state values to registers 810, 812, and 814. For example, circuit 800 may have a reset state in which registers 810, 812, and 814 all hold a value of zero.

Registers 810, 812, and 814 may be powered up at some initial state. As long as register 812 is powered up at state “0”, then the output of logic gate 806 will be forced low. If, however, register 812 is powered up to a high state, the only way the output of gate 804 will not be zero is if register 810 was also powered up to a high state. In this scenario, input b has to be set equal to “1” so that the output of NAND gate 802 will be forced low.

Therefore, consider a reset sequence in which input signals a and b are set to “0” and “1”, respectively. After a single clock cycle, registers 810 and 812 will latch a “0” and their respective outputs. As a result, AND gate 804 will output a zero, which will then force the output of AND gate 806 to zero as well. Since input signal b is high, register 814 will also latch a logic zero. In other words, regardless of the initial states of registers 810, 812, and 814, a reset sequence with {a=0, b=1} for a single clock cycle will deterministically reset all registers 810, 812, and 814 to the logic low state.

Tool 576 may be used to perform register retiming on circuit 800 of FIG. 8A to move register 810 across fan-out node 820, as indicated by dashed arrow 822. After retiming operations, circuit 800 of FIG. 8A may be transformed into retimed circuit 800′ of FIG. 8B. As shown in FGI. 8B, register 810 may be removed from the retimed circuit 800′ and replaced by registers 810-1 and 810-2. Register 810-1 is now coupled between fan-out node 820 and the second input of NAND gate 802, whereas register 810-2 is coupled between fan-out node 820 and the first input of AND gate 804. Configured in this way, registers 810-1 and 810-2 may receive input signal a directly at their inputs.

As previously described in connection with pre-retimed circuit 800 of FIG. 8A, register 814 may be at known value of logic “0” regardless of the previous values stored in registers 810 and 812 after the input vector a=0, b=1 is applied and the circuit is clocked once. In other words, the value stored at register 814 may be deterministic after a single clock cycle. However, in retimed circuit 800′, the value stored at register 814 may not be deterministic after one clock cycle.

For example, consider the scenario in which registers 810-1, 810-2, and 812 are initially powered up to logic values “0”, “1”, and “1”, respectively, with inputs similarly set to {a=0, b=1}. In this scenario, the output of both gates 802 and 804 will be at logic “1”, which means that signal h will be driven high after a single clock cycle. At this point, registers 810-1 and 810-2 will both be latching a low value, and thus an additional clock cycle will be needed to bring circuit 800′ to the correct reset state where all registers store a logic “0”. In other words, an additional clock cycle before application of the one vector reset sequence is needed here to help correlate the states of retimed registers 810-1 and 810-2.

Two sequential circuits are considered to be “sequentially equivalent” if for any state Sx in the first circuit, there exists a state Sy in the second circuit such that for any input sequence to the first circuit, the output sequence starting from Sx is the same as the output sequence in the second circuit starting from state Sy. In the example above, only a single clock cycle is required for circuit 800 of FIG. 8A to reach state Sx whereas at least two cycles are required for circuit 800′ of FGI. 8B to reach signal Sy. However, once circuits 800 and 800′ both reach Sx and Sy (i.e., the reset state), both circuits are considered sequentially equivalent from that point onwards.

In the example of FIG. 8, the original reset sequence used to reset circuit 800 of FIG. 8A had to be prepended by one empty clock cycle to ensure sequential equivalence for retimed circuit 800′. In accordance with an embodiment, one way to avoid altering and preserving the original reset sequence is for the retimer to compute and respect register initial states. Programmable integrated circuits may contain ample configuration memory that can help keep track of register initial states.

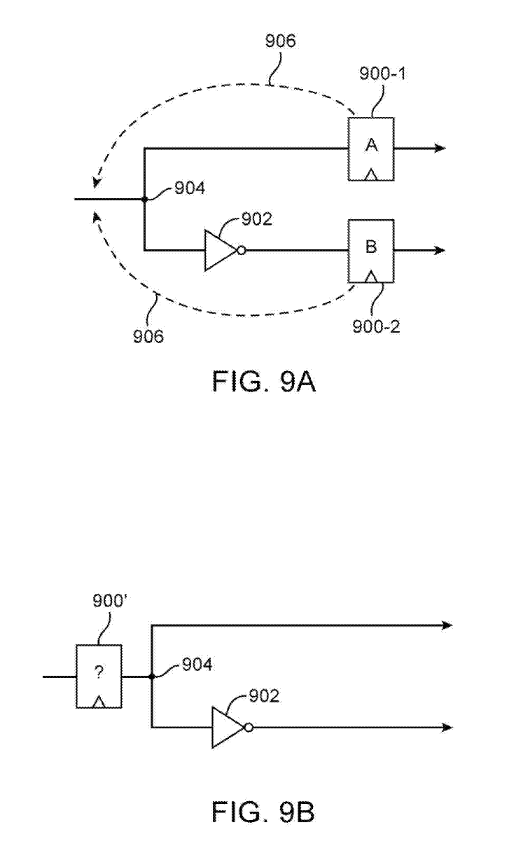

Always maintaining initial states can, however, restrict retiming (see, e.g., FIGS. 9A and 9B). FIG. 9A shows a circuit having a fan-out node 904 feeding a first register 900-1 and a second register 900-2. In particular, an inverter such as inverter 902 is coupled between fan-out node 904 and register 900-2. Register 900-1 may store a value A, whereas register 900-2 may store a value B.

Consider an example where tool 576 (FIG. 5) is used to perform backward register retiming such that registers 900-1 and 900-2 are moved backwards across fan-out node 904, as indicated by dashed arrows 906. The resulting retimed circuit is shown in FIG. 9B. As shown in FIG. 9B, retimed register 900′ may now feed fan-out node 904. If the initial states of the pre-retimed circuit of FIG. 9A were such that A=0 and B=1, then register 900′ in FIG. 9B would need to have a corresponding initial state of “0” to preserve the initial conditions. If, however, the initial states of the pre-retimed circuit of FIG. 9A were such that A=0 and B=0, then retiming would fail since there is no value that register 900′ can store to preserve the initial conditions. This is due to the presence of inverter 902, which forces the outputs of fan-out node 904 to be different. In such cases, a retiming move that could have potentially increased the maximum operating frequency (sometimes referred to as “Fmax”) of the circuit design was prevented. Maintaining all initial states when retiming can therefore limit Fmax since it is not always possible to compute a valid power-up state after the retiming move (as shown in the example of FIG. 9B).

In accordance with an embodiment, the register retiming operation might only need to maintain a subset of all initial states, thereby allowing more retiming operations to succeed and further improve Fmax. In general, backward retiming may be unrestricted since it does not alter functional equivalence. Similarly, forward retiming across justifiable combinational elements might also be unrestricted since it does not alter functional equivalence. Forward retiming across non-justifiable combinational elements, however, may require keeping track of initial states since doing so would result in a delayed equivalence (as illustrated in the example of FIGS. 8A-8B).

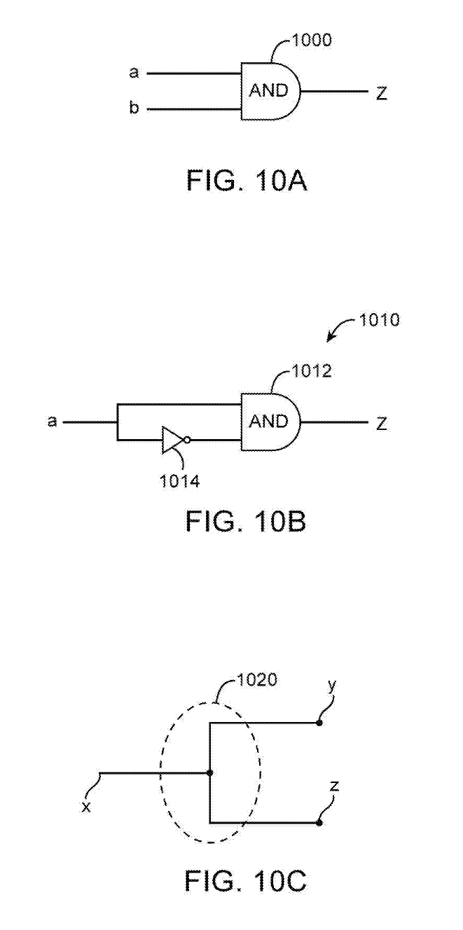

The concept of a justifiable/non-justifiable circuit element is illustrated in FIG. 10. A “justifiable” combinational circuit element is defined as a circuit element where all of its output value combinations is obtainable using some combination of its input values. Inversely, a “non-justifiable” combinational circuit element may be a circuit element that does not satisfy the requirements of a justifiable element. Consider, for example, a function F with n inputs and m outputs. Mathematically, function F is justifiable if and only if for every output yϵ2^{m}, there exists an input xϵ2ⁿ such that y=F(x). If, however, there exists a yϵ2^{m} such that for all xϵ2ⁿ, y≠F(x), then function F is not justifiable (or non-justifiable).

FIG. 10A shows an example of a justifiable combinational element such as a logic AND gate 1000. Logic AND gate 1000 may have first input a, second input b, and output z. Output z can be only either logic “0” or “1”. To obtain z=0, either input a or b has to be equal to 0. To obtain z=1, both inputs a and b have to be equal to 1. Because both output logic values “0” and “1” are separately obtainable, logic AND gate 1000 is a justifiable element.

FIG. 10B shows circuit 1010, which includes logic AND gate 1012 and inverter 1014. A first input of AND gate 1012 receives input a, while a second input of AND gate 1012 receives an inverted input a via inverter 1014. AND gate 1012 may generate an output value at output z. Output z can be only either logic “0” or “1”. To obtain z=0, input a can be equal to either 1 or 0. There is, however, no way to obtain z=1. Because at least an output logic value of “1” is unobtainable, circuit 1010 is a non-justifiable combinational element.

FIG. 10C shows another example of a non-justifiable combinational circuit element such as a fan-out node 1020. As shown in FIG. 10C, fan-out node 1020 may have a single input x, and outputs y and z. In particular, output value combinations in which the value at output y is different from the value at output z are unobtainable since the two output nodes are effectively shorted. In other words, fan-out node 1020 may not be able to generate an output combination where y=0 and z=1 or vice versa. Because at least one output combination is unobtainable, fan-out node 1020 is a non-justifiable combinational circuit element.

In general, a circuit that is retimed using only backward retiming moves (across either a justifiable or non-justifiable element) or retimed using forward retiming moves across justifiable elements is sequentially equivalent to the original circuit. To allow more retiming moves to succeed, which increases the flexibility of the retimer and thus improve Fmax, the retiming operation may be configured to leverage the existence of don't-care initial states among all of the initial states.

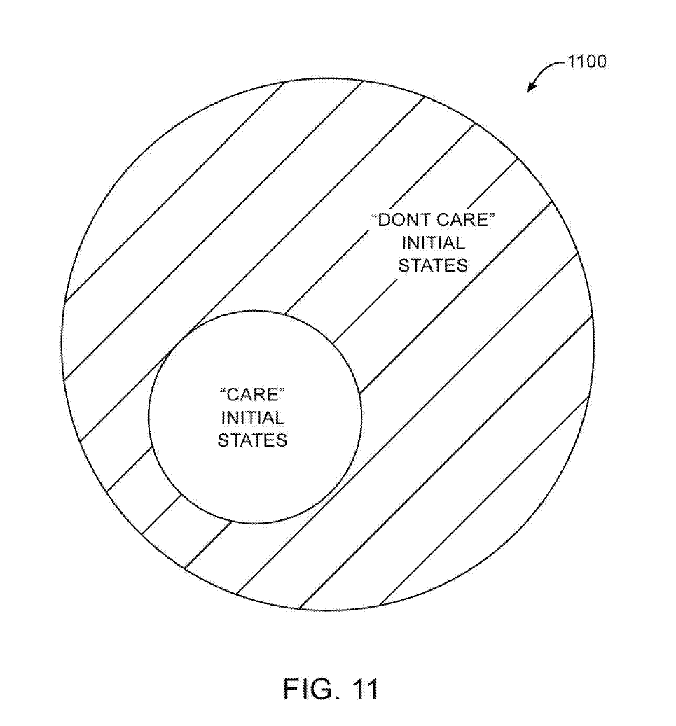

FIG. 11 is a diagram showing how an integrated circuit may have hybrid initial states in accordance with an embodiment. In many applications, circuit designers only care about the initial states of a small subset of flip-flops in the overall design. As shown in FIG. 11, only a small portion of the overall initial states 1100 represent “care” initial states (e.g., only a small portion requires a deterministic binary value of “0” or “1” upon power-up), whereas a large remaining part of the design has flip-flops with “don't-care” initial states (e.g., the user does not care what state in which those flip-flops are powered-up). For example, an integrated circuit might include one hundred thousand flip-flops, but only twenty thousand of which are associated with care initial states and eighty thousand of which are associated with don't-care initial states (represented by don't-care symbol “X”).

By leveraging hybrid initial states (i.e., by leverage the existence of care and don't-care initial states), Fmax is improved, and the original circuit reset sequence is guaranteed to work for the retimed circuit (without adding any empty cycles), so there is no use model change for the user. Moreover, existing third party EDA formal verification tools can be used to test and verify the functionality of the retimed circuit.

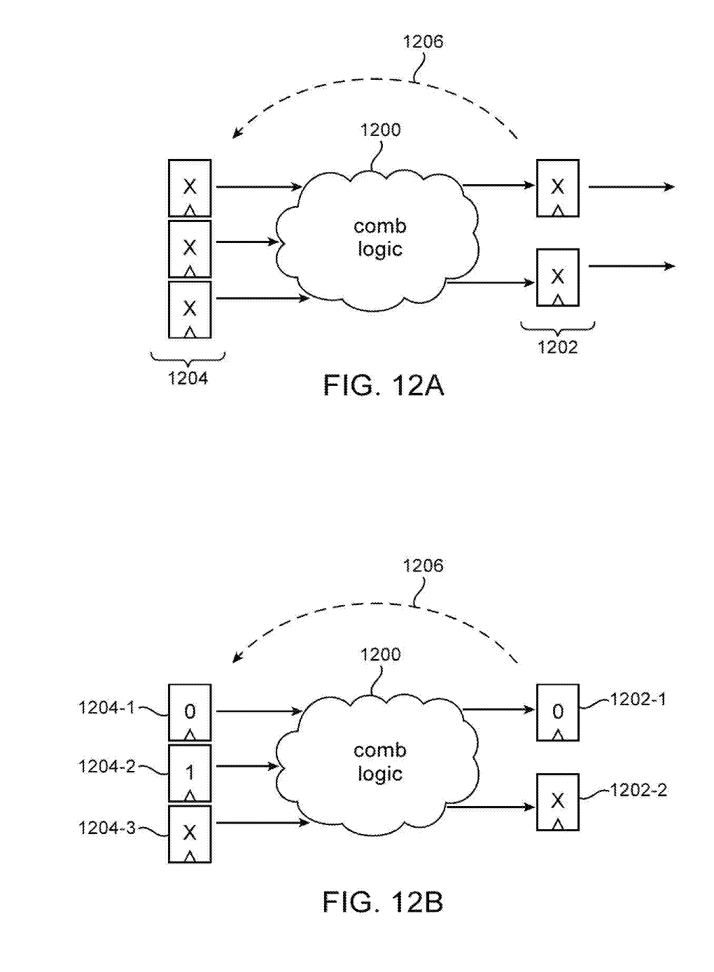

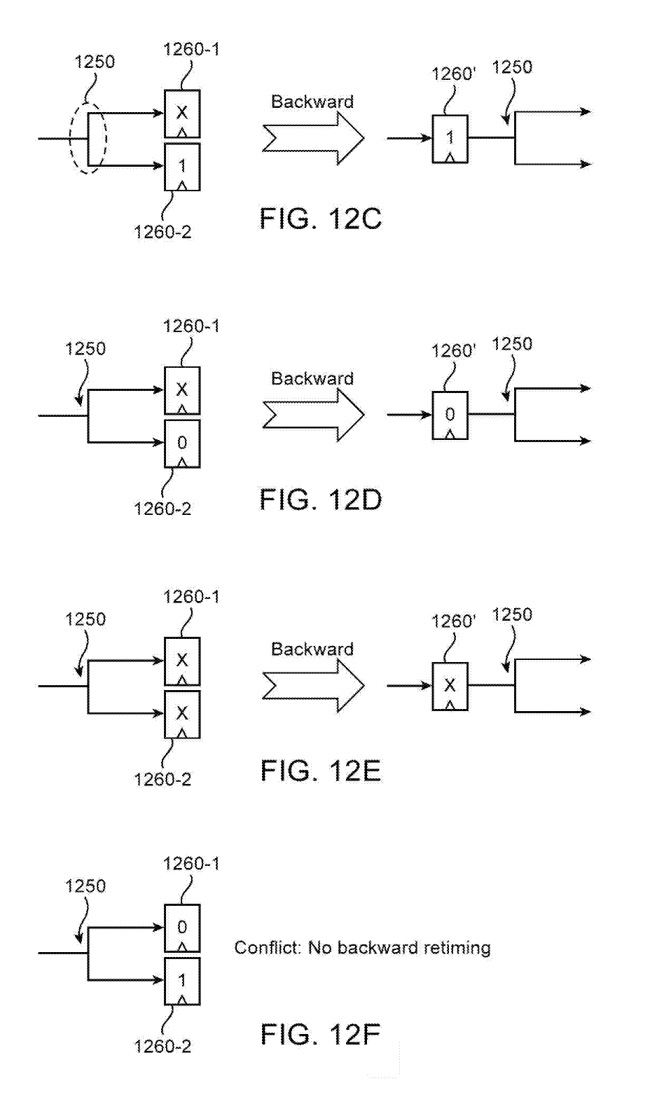

As described above, backward retiming does not alter functional equivalence. Thus, in theory, there is no need to respect initial states when performing backward retiming. However, if a user has specified some initial states (because they designed their reset sequence to start from that initial state), then those initial states should be respected during backward retiming. FIG. 12A illustrates an example where all of pre-retimed registers 1202 (e.g., flip-flops or other clocked storage element) have a don't-care (X) value. The output registers 1202 may be backward retimed across combinational logic 1200, as indicated by arrow 1206. Since all of the original pre-retimed registers 1202 have X values, all of the retimed registers 1204 may also exhibit don't-care (X) values.

FIG. 12B illustrates an example where some of the registers being backward retimed have a known initial state while some have a don't-care value. As shown in FIG. 12B, register 1202-1 may have a known initial state of “0”, whereas register 1202-2 has a don't-care initial state. The output registers 1202-1 and 1202-2 may be backward retimed across combinational logic 1200, as indicated by arrow 1206. There may be three resulting retimed registers 1204-1, 1204-2, and 1204-3 at the input of combinational logic 1200.

The initial states of registers 1204 should be computed such that they are consistent with the original initial states of registers 1202 and the functionality of combinational logic 1200 and while maximizing the number of don't-care X values. In the example of FIG. 12B, registers 1204-1, 1204-2, and 1204-3 may have computed initial states of “0”, “1”, and X, respectively. This is merely illustrative. As another example, registers 1204-1, 1204-2, and 1204-3 may have computed initial states equal to “1”, X, and X, respectively.

FIG. 12C illustrates a backward retiming across a fan-out node 1250. Registers 1260-1 and 1260-2 may be coupled at the outputs of fan-out node 1250 and may have initial states of X and “1”, respectively. After performing backward retiming, retimed register 1260′ may have a corresponding initial state of “1” to maintain the pre-retimed initial state for register 1260-2. Such initial state assignment might be pessimistic since it assumes that a logic “1” is still required at the bottom branch of fan-out node 1250.

FIG. 12D illustrates another exemplary backward retiming operation. Registers 1260-1 and 1260-2 may be coupled at the outputs of fan-out node 1250 and may have initial states of X and “0”, respectively. After performing backward retiming, retimed register 1260′ may have a corresponding initial state of “0” to maintain the pre-retimed initial state for register 1260-2. Such initial state assignment might be pessimistic since it assumes that a logic “0” is still required at the bottom branch of fan-out node 1250.

FIG. 12E illustrates yet another exemplary backward retiming operation. Registers 1260-1 and 1260-2 may be coupled at the outputs of fan-out node 1250 and may both have initial don't-care states. After performing backward retiming, retimed register 1260′ may have a corresponding initial state that is equal to X since both pre-retimed registers 1260 have don't-care initial states.

FIG. 12F illustrates an example where backward retiming is not allowed. As shown in FIG. 12F, registers 1260-1 and 1260-2 that are coupled at the outputs of fan-out node 1250 may have initial states of “0” and “1”, respectively. In such cases, backward retiming will not be allowed since there is no possible initial state for the retimed register that can respect both original initial states (e.g., it is not possible for a fan-out node to output two different values). Thus, only in this scenario will backward retiming be restricted. In most other cases, the presence of don't-care values X will allow backward retiming to proceed without restriction.

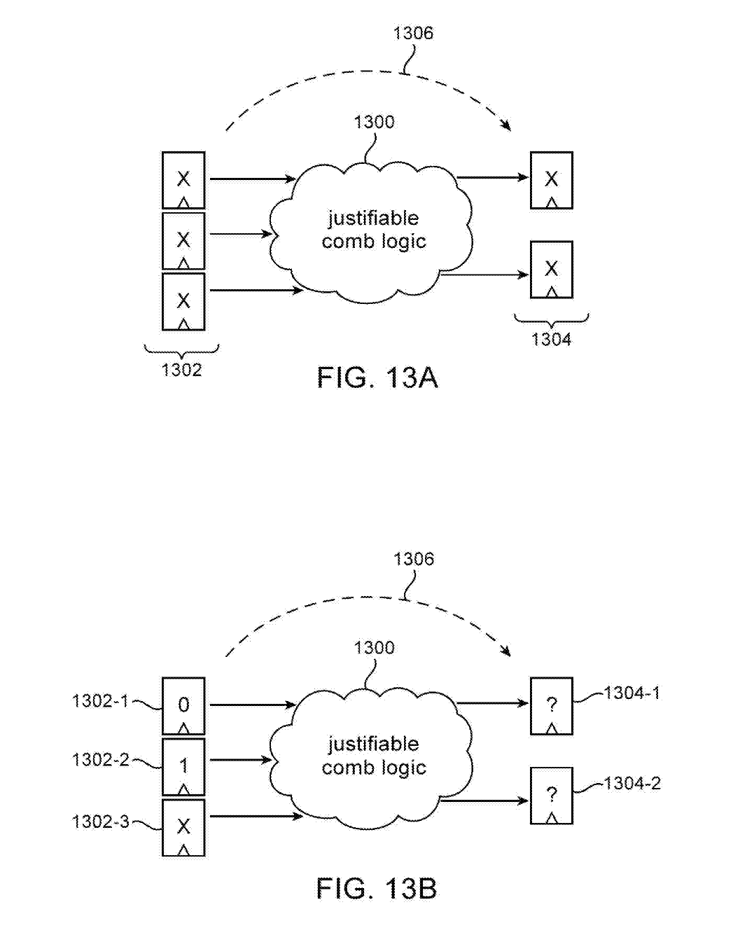

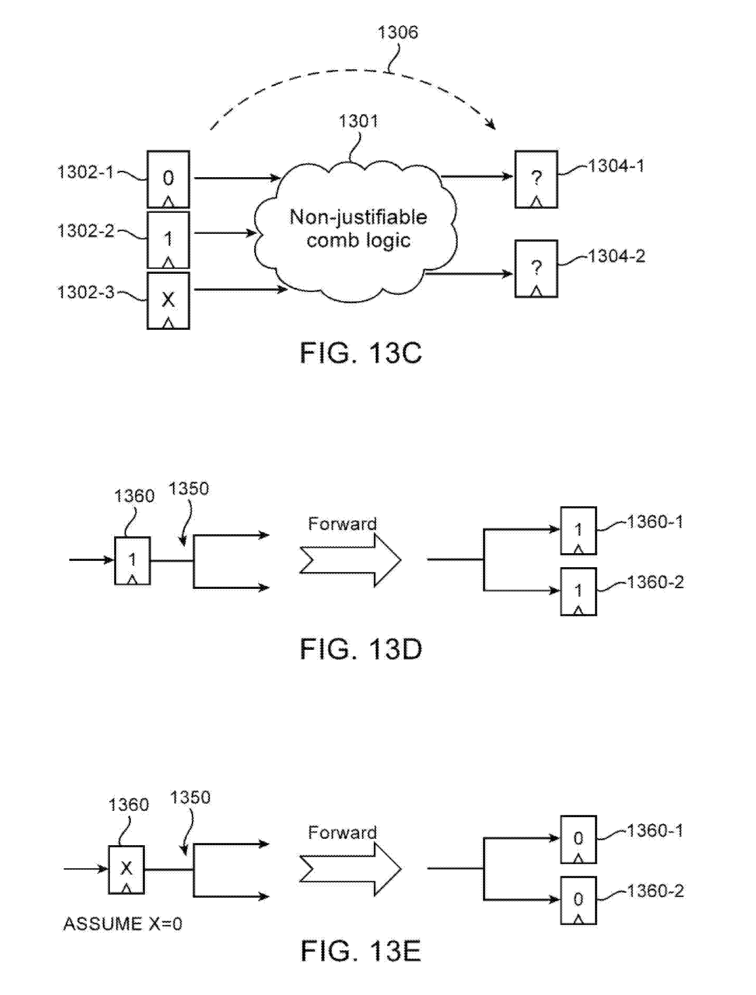

Similar to backward retiming, forward retiming across justifiable combinational elements may also involve respecting user-specified known states while maximizing the don't-care X states. FIG. 13A illustrates an example where all of the pre-retimed registers 1302 (e.g., flip-flops or other clocked storage element) have a don't-care (X) value. The input registers 1302 may be forward retimed across justifiable combinational logic 1300, as indicated by arrow 1306. Since all the original pre-retimed registers 1302 have X values, all the retimed registers 1304 may also exhibit don't-care (X) values.

FIG. 13B illustrates an example where some of the registers being forward retimed have a known initial state while some have a don't-care value. As shown in FIG. 13B, registers 1302-1, 1302-2, and 1302-3 may have initial states of “0”, “1”, and X, respectively. These input registers may be forward retimed across justifiable combinational logic 1300, as indicated by arrow 1306. There may be two resulting retimed registers 1304-1 and 1304-2 at the output of combinational logic 1300.

The initial states of registers 1304 should be computed such that they are consistent with the original initial states of registers 1302 and the functionality of combinational logic 1300 and while maximizing the number of don't-care X values. In the example of FIG. 13B, registers 1304-1 and 1304-2 may have computed initial states of “0” and X, respectively. This is merely illustrative. As another example, registers 1304-1 and 1304-2 may have computed initial states equal to “1” and “0”, respectively.

Forward retiming across non-justifiable elements, however, can cause delayed equivalence as illustrated in the example of FIGS. 8A and 8B. To avoid creating a delayed equivalent circuit and to guarantee that the user's reset sequence will work without having to prepend any empty clock cycles, it may be necessary to maintain initial states when forward retiming across non-justifiable elements. In accordance with an embodiment, the don't-care initial states may be converted into a “0” known state when performing forward retiming across a non-justifiable element. Although converting X states to a deterministic value would restrict the retimer, sequential equivalence (without having to delay the reset sequence) would be maintained.

FIG. 13C illustrates an example where some of the registers being forward retimed have a known initial state while some have a don't-care value. As shown in FIG. 13C, registers 1302-1, 1302-2, and 1302-3 may have initial states of “0”, “1”, and X, respectively. These input registers may be forward retimed across non-justifiable combinational logic 1301, as indicated by arrow 1306. There may be two resulting retimed registers 1304-1 and 1304-2 at the output of combinational logic 1300.

Here, all input X values are assumed to be equal to “0”. The initial states of the output register values may then be computed that are consistent with the functionality of the non-justifiable combinational logic 1301. As an example, registers 1304-1 and 1304-2 may have computed output initial state values of “1” and “0”, respectively. As another example, registers 1304-1 and 1304-2 may have computed output initial state values of “0” and “0”, respectively. Alternatively, registers 1304-1 and 1304-2 may have computed output initial state values of “0” and “1”, respectively.

FIG. 13D illustrates a forward retiming across a fan-out node 1350, which is an example of a non-justifiable circuit element. Register 1360 may be coupled at the input of fan-out node 1350 and may have an initial state of “1”. After performing forward retiming, retimed registers 1360-1 and 1360-2 may each have a corresponding initial state of “1” to maintain the pre-retimed initial state for register 1360.

FIG. 13E illustrates a forward retiming across a fan-out node 1350. In this example, register 1360 that is coupled at the input of fan-out node 1350 may have an initial don't-care state. Again, the retimer may assume that X is equal to “0”. After performing forward retiming, retimed registers 1360-1 and 1360-2 may each have a corresponding initial state of “0” to maintain the pre-retimed assumed initial state for register 1360.

The examples described above in which X is assumed to be equal to a predetermined binary value of “0” when performing forward retiming across non-justifiable elements is merely illustrative. If desired, the don't-care initial states may be assumed to be equal to a predetermined binary value of “1” when performing forward retiming across non-justifiable elements. Alternatively, retiming may simply disallow any forward retiming across non-justifiable combinational elements at the expense of Fmax.

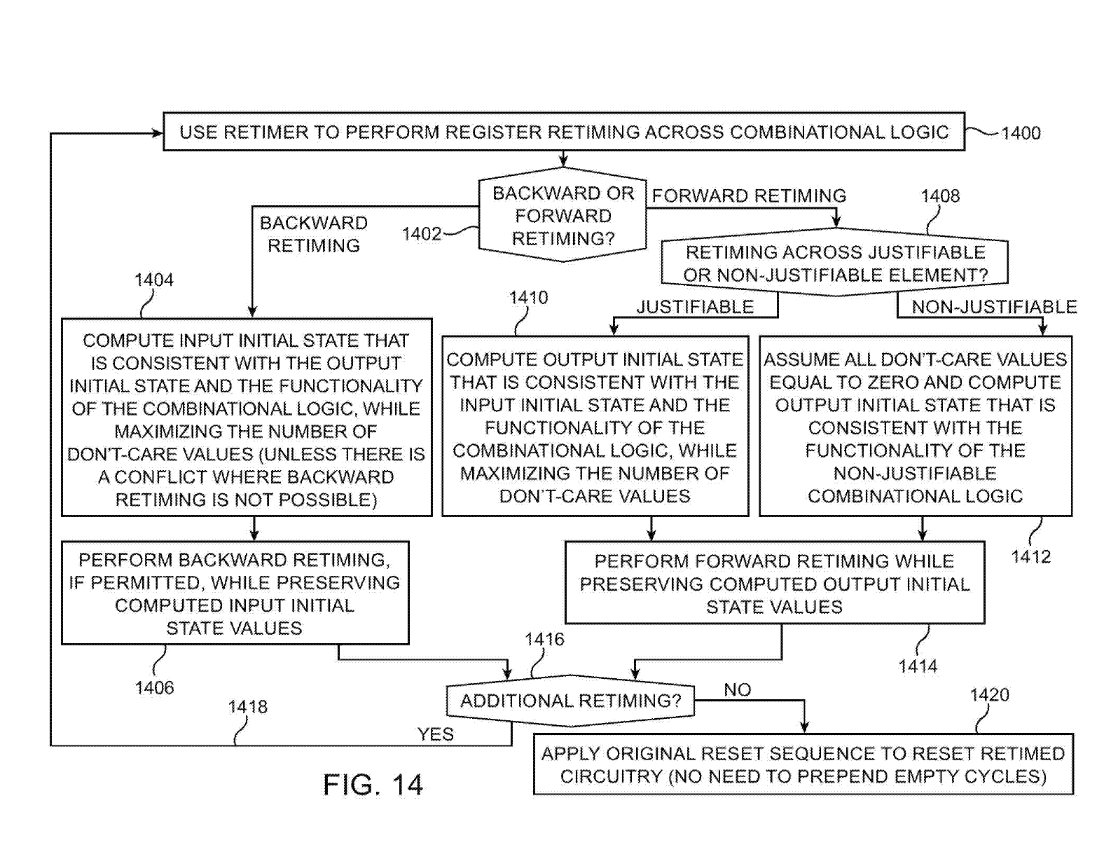

FIG. 14 is a flow chart of illustrative steps for performing register retiming with hybrid initial states. At step 1400, the retimer implemented on tool 576 (FIG. 5) may be used to perform register retiming across combinational logic (e.g., across either a justifiable or non-justifiable combinational circuit element).

At step 1402, the retimer may determine whether the retiming operation to be performed is a backward or forward retiming operation. In response to determining that a backward retiming is to be performed, the retimer may compute an input initial state (e.g., the initial state for the retimed input registers) that is consistent with the output initial state (e.g., the initial state of the pre-retimed output registers) and the functionality of the combinational logic (step 1404). Meanwhile, the retimer will strive to maximize the number of don't-care values in the computed input initial states. Backward retiming will be allowed unless there is a conflict (see, e.g., FIG. 12F).

At step 1406, backward retiming is performed while preserving the computed input initial state values (e.g., the retimed registers will be powered up in the computed initial states).

In response to determining that a forward retiming is to be performed, the retimer may further determine whether the current retiming operation is retiming across a justifiable or non-justifiable circuit element (step 1408). When retiming across a justifiable combinational element, the retimer may compute an output initial state that is consistent with the input initial states and the functionality of the combinational logic (step 1410). Meanwhile, the retimer will strive to maximize the number of don't-care values in the computed output initial states.

When retiming across a non-justifiable combinational element, the retimer may assume that all don't-care values are equal to logic “0” (or other predetermined binary value) and then compute an output initial state that is consistent with the functionality of the non-justifiable combinational logic (step 1412).

At step 1414, forward retiming is performed while preserving the computed output initial state values (e.g., the retimed registers will be powered up in the computed initial states).

At step 1416, the retimer will determine whether additional retiming is required. If so, processing will loop back to step 1400 to perform another retiming operation, as indicated by path 1418. If retiming is complete, the resulting circuit design is ready to be reset using the original reset sequence that was previously applied to the pre-retimed circuit (step 1420). There is no need to prepend empty clock cycles, so there is no use model change for the user.

These steps are merely illustrative. The existing steps may be modified or omitted; some of the steps may be performed in parallel; additional steps may be added; and the order of certain steps may be reversed or altered.

The embodiments thus far have been described with respect to integrated circuits. The methods and apparatuses described herein may be incorporated into any suitable circuit. For example, they may be incorporated into numerous types of devices such as programmable logic devices, application specific standard products (ASSPs), and application specific integrated circuits (ASICs), microcontrollers, microprocessors, central processing units (CPUs), graphics processing units (GPUs), etc. Examples of programmable logic devices include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The programmable logic device described in one or more embodiments herein may be part of a data processing system that includes one or more of the following components: a processor; memory; IO circuitry; and peripheral devices. The data processing can be used in a wide variety of applications, such as computer networking, data networking, instrumentation, video processing, digital signal processing, or any suitable other application where the advantage of using programmable or re-programmable logic is desirable. The programmable logic device can be used to perform a variety of different logic functions. For example, the programmable logic device can be configured as a processor or controller that works in cooperation with a system processor. The programmable logic device may also be used as an arbiter for arbitrating access to a shared resource in the data processing system. In yet another example, the programmable logic device can be configured as an interface between a processor and one of the other components in the system.

### Examples

The following examples pertain to further embodiments.

Example 1 is a method of operating an integrated circuit design tool implemented on computing equipment, comprising: receiving a circuit design that includes a register coupled to a combinational element; determining an initial state for the register; and in response to determining that the initial state of the register is a don't-care initial state, performing retiming by moving the register across the combinational element.

Example 2 is the method of example 1, optionally further comprising computing an initial state for the retimed register.

Example 3 is the method of example 2, wherein the computed initial state is optionally consistent with the initial state of the register and the functionality of the combinational element.

Example 4 is the method of example 2, optionally further comprising maximizing the number of don't-care initial states when computing the initial state for the retimed register and when the retiming is a backward retiming operation.

Example 5 is the method of example 2, optionally further comprising maximizing the number of don't-care initial states when computing the initial state for the retimed register and when the retiming is a forward retiming operation across the combinational element that is a justifiable combinational element.

Example 6 is the method of any one of examples 2-5, wherein the retiming is a forward retiming move, the method optionally further comprising: determining whether the combinational element is a non-justifiable circuit element; and in response to determining that the combinational element is a non-justifiable circuit element, assuming that the don't-care initial state of the register before the forward retiming move is equal to a deterministic binary value.

Example 7 is the method of example 6, wherein the computed initial state of the register after the forward retiming move is optionally consistent with the assumed deterministic binary value of the register and the functionality of the non-justifiable circuit element.

Example 8 is the method of example 6, wherein the non-justifiable circuit element is optionally a fan-out node.

Example 9 is the method of any one of examples 1-5, wherein the circuit design and a retimed version of the circuit design produced after retiming are optionally reset using the same reset sequence.

Example 10 is a method of implementing an integrated circuit using integrated circuit design tools running on computing equipment, comprising: receiving an original circuit design having a plurality of registers coupled to a combinational logic, the plurality of registers have hybrid initial states; and retiming the original circuit design to produce a retimed circuit design while taking into account the hybrid initial states of the plurality of registers.

Example 11 is the method of example 10, wherein the hybrid initial states optionally include don't-care initial states.

Example 12 is the method of example 11, wherein both the original circuit design and the retimed circuit design can optionally be properly reset using the same reset sequence.

Example 13 is the method of example 11, wherein retiming the original circuit design optionally comprises performing a backward retiming operation while maximizing the number of don't-care initial states in the retimed circuit design.

Example 14 is the method of example 11, wherein retiming the original circuit design optionally comprises performing a forward retiming operation across a justifiable combinational element while maximizing the number of don't-care initial states in the retimed circuit design.

Example 15 is the method of any one of examples 11-14, optionally further comprising: determining whether the plurality of registers are being forward retimed across a non-justifiable combinational element; and in response to determining that the plurality of registers are being forward retimed across a non-justifiable combinational element, assuming that the don't-care initial states of the registers before the retiming are equal to a predetermined logic value and that the initial states of the registers after the retiming are computed to be consistent with the functionality of the non-justifiable combinational element.

Example 16 is non-transitory computer-readable storage media comprising instructions for: retiming an original circuit design to produce a retimed circuit design; determining initial states for the original circuit design, wherein the initial states include don't-care initial states; and computing initial states for the retimed circuit design, wherein both the original circuit design and the retimed circuit design are properly reset using the same reset sequence.

Example 17 is the non-transitory computer-readable storage media of example 16, wherein the instructions for computing the initial states for the retimed circuit design optionally comprise instructions for computing the initial states for the retimed circuit design that is consistent with the initial states of the original circuit design and the functionality of a combinational element across which the retiming is performed.

Example 18 is the non-transitory computer-readable storage media of example 16, wherein the instructions for retiming the original circuit design to produce the retimed circuit design optionally comprise instructions for performing backward retiming while maximizing the number of don't-care initial states when computing the initial states for the retimed circuit design.

Example 19 is the non-transitory computer-readable storage media of any one of examples 16-18, wherein the instructions for retiming the original circuit design to produce the retimed circuit design optionally comprise instructions for performing forward retiming across a justifiable combinational element while maximizing the number of don't-care initial states when computing the initial states for the retimed circuit design.

Example 20 is the non-transitory computer-readable storage media of example 19, wherein the instructions for retiming the original circuit design to produce the retimed circuit design further optionally comprise instructions for performing forward retiming across a non-justifiable combinational element by assuming that the don't-care initial states of registers being retimed across the non-justifiable combinational element in the original circuit design are set to a deterministic value.

Example 21 is integrated circuit design tools running on computing equipment, comprising: means for receiving an original circuit design having a plurality of registers coupled to a combinational logic, the plurality of registers have hybrid initial states, wherein the hybrid initial states include don't-care initial states; and means for retiming the original circuit design to produce a retimed circuit design while taking into account the hybrid initial states of the plurality of registers.

Example 22 is the integrated circuit design tools of example 21, wherein both the original circuit design and the retimed circuit design can optionally be properly reset using the same reset sequence.

Example 23 is the integrated circuit design tools of example 21, wherein the means for retiming the original circuit design optionally comprises means for performing a backward retiming operation while maximizing the number of don't-care initial states in the retimed circuit design.

Example 24 is the integrated circuit design tools of example 21, wherein the means for retiming the original circuit design optionally comprises means for performing a forward retiming operation across a justifiable combinational element while maximizing the number of don't-care initial states in the retimed circuit design.

Example 25 is the integrated circuit design tools of any one of examples 21-24, further optionally comprising: means for determining whether the plurality of registers are being forward retimed across a non-justifiable combinational element; and means for assuming that the don't-care initial states of the registers before the retiming are equal to a predetermined logic value and that the initial states of the registers after the retiming are computed to be consistent with the functionality of the non-justifiable combinational element, in response to determining that the plurality of registers are being forward retimed across a non-justifiable combinational element.

For instance, all optional features of the apparatus described above may also be implemented with respect to the method or process described herein. The foregoing is merely illustrative of the principles of this disclosure and various modifications can be made by those skilled in the art.

1. A method of operating an integrated circuit design tool implemented on computing equipment, comprising:
receiving a circuit design that includes a register coupled to a combinational element;
determining an initial state for the register; and
in response to determining that the initial state of the register is a don't-care initial state, performing retiming by moving the register across the combinational element, wherein the retiming is a forward retiming move;
determining whether the combinational element is a non-justifiable circuit element;
in response to determining that the combinational element is a non-justifiable circuit element, assuming that the don't-care initial state of the register before the forward retiming move is equal to a deterministic binary value; and
computing an initial state for the retimed register.

2. (canceled)

3. The method of claim 1, wherein the computed initial state is consistent with the initial state of the register and the functionality of the combinational element.

4. The method of claim 1, further comprising maximizing the number of don't-care initial states when computing the initial state for the retimed register and when the retiming is a backward retiming operation.

5. The method of claim 1, further comprising maximizing the number of don't-care initial states when computing the initial state for the retimed register and when the retiming is a forward retiming operation across the combinational element that is a justifiable combinational element.

6. (canceled)

7. The method of claim 1, wherein the computed initial state of the register after the forward retiming move is consistent with the assumed deterministic binary value of the register and the functionality of the non-justifiable circuit element.

8. The method of claim 1, wherein the non-justifiable circuit element is a fan-out node.

9. The method of claim 1, wherein the circuit design and a retimed version of the circuit design produced after retiming are reset using the same reset sequence.

10. A method of implementing an integrated circuit using integrated circuit design tools running on computing equipment, comprising:
receiving an original circuit design having a plurality of registers coupled to a combinational logic, the plurality of registers have hybrid initial states; and
retiming the original circuit design to produce a retimed circuit design while taking into account the hybrid initial states of the plurality of registers, wherein both the original circuit design and the retimed circuit design are properly reset using the same reset sequence within the same number of clock cycles.

11. The method of claim 10, wherein the hybrid initial states include don't-care initial states.

12. (canceled)

13. The method of claim 11, wherein retiming the original circuit design comprises performing a backward retiming operation while maximizing the number of don't-care initial states in the retimed circuit design.

14. The method of claim 11, wherein retiming the original circuit design comprises performing a forward retiming operation across a justifiable combinational element while maximizing the number of don't-care initial states in the retimed circuit design.

15. The method of claim 11, further comprising:
determining whether the plurality of registers are being forward retimed across a non-justifiable combinational element; and
in response to determining that the plurality of registers are being forward retimed across a non-justifiable combinational element, assuming that the don't-care initial states of the registers before the retiming are equal to a predetermined logic value and that the initial states of the registers after the retiming are computed to be consistent with the functionality of the non-justifiable combinational element.

16. Non-transitory computer-readable storage media comprising instructions for:
retiming an original circuit design to produce a retimed circuit design;
determining initial states for the original circuit design, wherein the initial states include don't-care initial states; and
computing initial states for the retimed circuit design, wherein both the original circuit design and the retimed circuit design are properly reset using the same reset sequence within the same number of clock cycles.

17. The non-transitory computer-readable storage media of claim 16, wherein the instructions for computing the initial states for the retimed circuit design comprise instructions for computing the initial states for the retimed circuit design that is consistent with the initial states of the original circuit design and the functionality of a combinational element across which the retiming is performed.

18. The non-transitory computer-readable storage media of claim 16, wherein the instructions for retiming the original circuit design to produce the retimed circuit design comprise instructions for performing backward retiming while maximizing the number of don't-care initial states when computing the initial states for the retimed circuit design.

19. The non-transitory computer-readable storage media of claim 16, wherein the instructions for retiming the original circuit design to produce the retimed circuit design comprise instructions for performing forward retiming across a justifiable combinational element while maximizing the number of don't-care initial states when computing the initial states for the retimed circuit design.

20. The non-transitory computer-readable storage media of claim 19, wherein the instructions for retiming the original circuit design to produce the retimed circuit design further comprise instructions for performing forward retiming across a non-justifiable combinational element by assuming that the don't-care initial states of registers being retimed across the non-justifiable combinational element in the original circuit design are set to a deterministic value.
